(19) United States
(12) Patent Application Publication
(10) Pub. No.: US 2015/0294314 A1
(43) Pub. Date: Oct. 15, 2015

(54) SYSTEM AND METHOD OF PROVIDING MULTINATIONAL CARD PROGRAMS

(71) Applicant: MasterCard International Incorporated, Purchase, NY (US)

(72) Inventors: Sambit PATTANAYAK, White Plains, NY (US); Edward GLASSMAN, Pleasantville, NY (US); Richard Francis CRUM, Stamford, CT (US)

(73) Assignee: MasterCard International Incorporated, Purchase, NY (US)

(21) Appl. No.: 14/248,706

(22) Filed: Apr. 9, 2014

(51) Int. Cl. G06Q 20/40; G06F 17/30

(52) U.S. Cl. CPC G06Q 20/409; G06F 17/30386

(57) ABSTRACT

A method for facilitating a transaction includes: storing card association data entries, each including at least a card association number (ICA), a country associated with the ICA, and a plurality of bank identification numbers (BINs) associated with the ICA; receiving a number request originating from a first country and identifying a second country; identifying a specific data entry where the included country corresponds to the second country; identifying a subset of BINs of the plurality associated with the ICA in the specific data entry; transmitting the identified subset of BINs; receiving an authorization request for a financial transaction originating from the second country and including at least a payment card number, the number being associated with a BIN included in the subset of BINs; processing the financial transaction as a local transaction and not a cross-border transaction; and transmitting an authorization response indicating approval or denial of the financial transaction.

### FIELD

The present disclosure relates to the processing of financial transactions involving payment cards issued to employees of a multinational corporation, specifically the processing of financial transactions involving a payment card issued by an issuer in a first country to an employee in a second country as a local transaction in the second country.

### BACKGROUND

Multinational corporations and other such entities that have a presence in multiple countries (“MNCs”) often have employees or other actors who live in or regularly spend in each of the countries where the MNC has a presence. MNCs may often have an account with an issuing bank in their home country, where their headquarters may be located, for issuing payment cards to employees. However, due to various laws, regulations, and licensing requirements, many issuers do not have a presence in additional countries. As a result, MNCs may often times be unable to have payment cards issued to their employees in other subsidiary countries by their main issuing bank.

In order to help facilitate the issuing of payment cards and tracking of data, payment networks have developed methods for assistance in the creation of partnerships among issuers. For example, MasterCard® identifies a network of issuers around the world, countries which the issuer supports, and various products supported by the issuer. The main issuing bank for the MNC may then identify suitable partnering issuers in targeted subsidiary countries, partner with those issuers, who may then issue cards to the MNC employees in the corresponding subsidiary countries. VISA® also identifies potential partners, which issuing banks may contact, to allow for issuing banks to develop partnerships to cover subsidiary countries. VISA® has also developed a preferred network of issuers that cover a large number of countries, where an MNC may contract with a lead issuer in the network and have the benefit of the already-partnered subordinate issuers covering subsidiary countries.

However, such systems that are currently used often suffer from several disadvantages. Some MNCs may only do a small amount of business in a subsidiary country, which may result in the partnered issuer in that country not providing the same level of support and customer service to the MNC or main issuer. In addition, managing a large network of partnered issuers may be difficult or time consuming for the MNC or main issuer, which may result in the additional expense of time and/or resources. Furthermore, it may be difficult for the main issuer to aggregate and gather data for the purposes of reporting to the MNC, which may in turn make it more difficult for the MNC to evaluate and manage spending in subsidiary countries.

In an effort to provide a solution to the disadvantages of utilizing a network of partnering issuers, MasterCard® has developed a system where the main issuer for an MNC located in the home country may “follow their customer.” Using such a system, the main issuer may issuer a payment card associated with the home country to an employee located in a subsidiary country. Such a system may enable the issuer to issue payment cards to subsidiary employees without the need to expend time and resources obtaining a license in the subsidiary country, and may also enable the main issuer to serve the MNC without having to include additional issuers. However, such a system may also suffer from further disadvantages. Because the payment card is associated with the home country but used in the subsidiary country, transactions conducted with the payment card may be considered a cross-border transaction. Such transactions may incur additional fees and expenses, and may also require one or more currency exchanges, which may result in additional fees and/or losses. Furthermore, the main issuer may be required to develop infrastructure in the subsidiary country to provide support when not possible from the home country. Accordingly, both types of methods used currently for an issuer to support an MNC in subsidiary countries suffer from several disadvantages.

Thus, there is a need for a technical solution to enable an issuer to provide payment cards to MNC employees in subsidiary countries without having to partner with other issuers or issue payment cards subject to cross-border fees and currency exchanges.

### SUMMARY

The present disclosure provides a description of systems and methods for the facilitating of payment card transactions.

A method for facilitating a payment card transaction includes: storing, in a database, a plurality of card association data entries, wherein each card association data entry includes data related to payment card numbers and includes at least a card association number (ICA), a country associated with the ICA, and a plurality of bank identification numbers (BINs) associated with the ICA; receiving, by a receiving device, a number request from an issuer, wherein the number request originates from a first country and identified a second country; identifying, in the database, a specific card association data entry where the included country corresponds to the second country identified in the number request; identifying, by a processing device, a subset of BINs of the plurality of BINs associated with the ICA included in the specific card association data entry; transmitting, by a transmitting device, the identified subset of BINs to the issuer; receiving, by the receiving device, an authorization request for a financial transaction, wherein the authorization request originates from the second country identified in the number request and includes at least a payment card number, the payment card number being associated with a payment card issued by the issuer and being associated with a BIN included in the subset of BINs; processing, by the processing device, the financial transaction as a local transaction such that the financial transaction is not a cross-border transaction; and transmitting, by the transmitting device, an authorization response indicating approval or denial of the financial transaction in response to the received authorization request.

Another method for facilitating a payment card transaction includes: storing, in a database, a plurality of card association data entries, wherein each card association data entry includes data related to payment card numbers and includes at least a card association number (ICA) and a plurality of bank identification number (BIN) ranges, each BIN range being associated with a country; receiving, by a receiving device, a number request from an issuer, wherein the number request originates from a first country and identified a second country; identifying, in the database, a specific card association data entry where the at least one BIN range included in the plurality of BIN ranges included in the specific card association data entry is associated with the second country; transmitting, by a transmitting device, at least the ICA and the at least one BIN range included in the specific card association data entry to the issuer; receiving, by the receiving device, an authorization request for a financial transaction, wherein the authorization request originates from the second country identified in the number request and includes at least a payment card number, the payment card number being associated with a payment card issued by the issuer and being associated with a BIN included in the at least one BIN range; processing, by the processing device, the financial transaction as a local transaction such that the financial transaction is not a cross-border transaction; and transmitting, by the transmitting device, an authorization response indicating approval or denial of the financial transaction in response to the received authorization request.

A system for facilitating a payment card transaction includes a database, a receiving device, a processing device, and a transmitting device. The database is configured to store a plurality of card association data entries, wherein each card association data entry includes data related to payment card numbers and includes at least a card association number (ICA), a country associated with the ICA, and a plurality of bank identification numbers (BINs) associated with the ICA. The receiving device is configured to receive a number request from an issuer, wherein the number request originates from a first country and identified a second country. The processing device is configured to identify, in the database, a specific card association data entry where the included country corresponds to the second country identified in the number request, and identify a subset of BINs of the plurality of BINs associated with the ICA included in the specific card association data entry. The transmitting device is configured to transmit the identified subset of BINs to the issuer. The receiving device is further configured to receive an authorization request for a financial transaction, wherein the authorization request originates from the second country identified in the number request and includes at least a payment card number, the payment card number being associated with a payment card issued by the issuer and being associated with a BIN included in the subset of BINs. The processing device is further configured to process the financial transaction as a local transaction such that the financial transaction is not a cross-border transaction. The transmitting device is further configured to transmit an authorization response indicating approval or denial of the financial transaction in response to the received authorization request.

Another system for facilitating a payment card transaction includes a database, a receiving device, a processing device, and a transmitting device. The database is configured to store a plurality of card association data entries, wherein each card association data entry includes data related to payment card numbers and includes at least a card association number (ICA) and a plurality of bank identification number (BIN) ranges, each BIN range being associated with a country. The receiving device is configured to receive a number request from an issuer, wherein the number request originates from a first country and identified a second country. The processing device is configured to identify, in the database, a specific card association data entry where the at least one BIN range included in the plurality of BIN ranges included in the specific card association data entry is associated with the second country. The transmitting device is configured to transmit at least the ICA and the at least one BIN range included in the specific card association data entry to the issuer. The receiving device is further configured to receive an authorization request for a financial transaction, wherein the authorization request originates from the second country identified in the number request and includes at least a payment card number, the payment card number being associated with a payment card issued by the issuer and being associated with a BIN included in the at least one BIN range. The processing device is further configured to process the financial transaction as a local transaction such that the financial transaction is not a cross-border transaction. The transmitting device is further configured to transmit an authorization response indicating approval or denial of the financial transaction in response to the received authorization request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the facilitating of payment transactions as local transactions in a subsidiary country in accordance with exemplary embodiments.

FIG. 2 is a block diagram illustrating the processing server of FIG. 1 for the processing and facilitating of payment card transactions in accordance with exemplary embodiments.

FIGS. 3A and 3B are a process flow illustrating a method for issuing a payment card and facilitating a payment transaction including the payment card using the system of FIG. 1 in accordance with exemplary embodiments.

FIGS. 4 and 5 are flow diagrams illustrating methods for processing payment card transactions using the system of FIG. 1 in accordance with exemplary embodiments.

FIGS. 6 and 7 are flow charts illustrating exemplary methods for facilitating a payment card transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable. Payment cards may also include real card accounts having associated real card account numbers (RCAs) and mobile cloud accounts having associated mobile cloud account numbers (MCAs) as discussed in more detail herein.

### System for Facilitating Payment Card Transactions in a Subsidiary Country

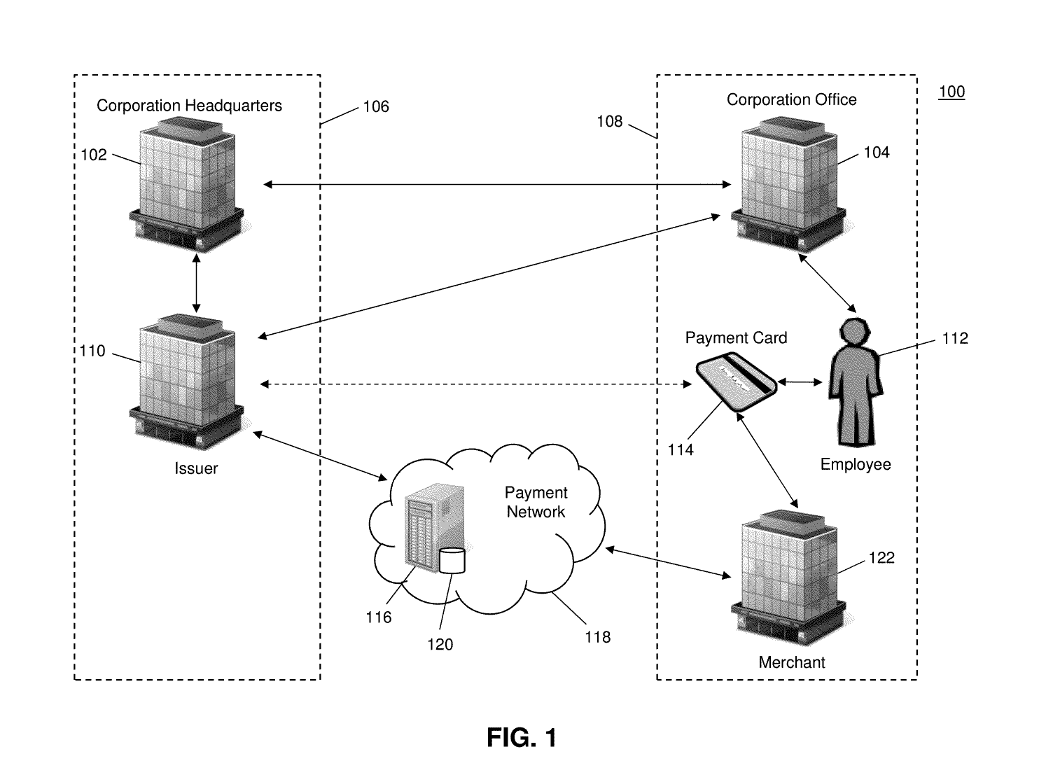

FIG. 1 illustrates a system 100 for the facilitating of payment card transactions initiated in a subsidiary country utilizing a payment card issued by an issuer located in a home country.

A corporation headquarters 102 may be an office of an MNC or other entity located in a first, or home, country 106. In some embodiments, the corporation headquarters 102 may be the home, or main, office of the MNC or entity, or may be an office located in the same first country 106 as an issuer 110 (e.g., an issuing bank) of whom the MNC is a customer. The issuer 110 may be located in the first country 106 and may have one or more accounts with which the MNC is associated. The MNC may also have a corporation office 104 located in a second, or subsidiary, country 108. The corporation office 104 may support one or more employees 112 also located in the second country 108.

The issuer 110 may be in communication with a payment network 118, which may be configured to process financial transactions in both the first country 106 and the second country 108. The payment network 118 may include a processing server 116, discussed in more detail below. It will be apparent to persons having skill in the relevant art that the processing server 116 may be included as part of the payment network 118 or may be external to the payment network 118 and connected via a network, such as the Internet.

The processing server 116 may include a card association database 120. The card association database 120 may be configured to store a plurality of card association data entries, which may include data related to payment card numbers. The processing server 116 (e.g., the payment network 118) may receive and store in the card association database 120 a card association number (ICA) corresponding to the second country 108. Numbers that may be suitable as the ICA will be apparent to persons having skill in the relevant art, such as an Interbank Card Association Number. The processing server 116 may also store ICAs corresponding to additional subsidiary countries. In some embodiments, the processing server 116 may store card association data entries in the card association database 120 including multiple ICAs associated with a single country. Each ICA stored in the card association database 120 may be associated with a plurality of bank identification numbers (BINs). Types of BINs will be apparent to persons having skill in the relevant art and may include portions of, such as the first four digits to, payment card numbers.

The issuer 110 may submit a number request to the processing server 116, requesting numbers for use in issuing payment cards in the second country 108. The processing server 116 may identify the second country 108 indicated in the number request and may then identify the card association data entry in the card association database 120 corresponding to the second country 108. The processing server 116 may then identify a subset of BINs, which may then be associated with the issuer 110, and then transmitted to the issuer 110. The issuer 110 may then issue a payment card 114 to the corporation office 104 located in the second country 108, to be provided to the employee 112 in the second country 108. In some embodiments, the issuer 110 may issue the payment card 114 directly to the employee 112. The payment card 114 may correspond to a payment card number including a BIN from the subset of BINs assigned to the issuer 110 for the second country 108. As such, the payment card number corresponding to the payment card 114 may be a local number associated with the second country 108. In some instances, the processing server 116 may associate an ICA with (e.g., or distribute an ICA to) the issuer 110 for each additional country (e.g., the second country 108) in which the issuer 110 wants to issue payment cards to.

The use of the processing server 116 for possessing ICAs and then distributing a subset of BINs to the issuer 110 may enable the issuer 110 to issue payment cards in the second country 108, without requiring the issuer 110 to obtain licenses in the second country 108 or develop any specific infrastructure in the second country 108. Such a system may enable the issuer 110 to support employees 112 of the MNC in the second country 108 without incurring additional fees and expenses resulting from cross-border transactions, and also without expending significant time and resources in order to obtain and utilize an ICA associated with that country. In addition, due to the inability for some merchants to accept cross-border transactions, the employee 112 may be able to transact at a larger number of merchants 122 in the second country 108 using the payment card 114 than with a traditionally-issued payment card.

In an alternative embodiment, the processing server 116 may store a plurality of card association data entries in the card association database 120 with each one including a single ICA and a plurality of BIN ranges, wherein each BIN range is associated with a country. In such an embodiment, the processing server 116 may assign the ICA included in a specific card association database 120 with the issuer 110, and then may provide a specific BIN range corresponding to the second country 108 as associated with that ICA to the issuer 110. This way, a single ICA may be used to support the issuer 110 in multiple subsidiary countries, with each BIN range used to for payment cards in a particular subsidiary country with support for local transactions.

Once the payment card 114 has been provisioned to the employee 112, the employee 112 may use the payment card 114 to conduct a financial transaction with a merchant 122 in the second country 108. The merchant 122, or an acquirer (e.g., an acquiring bank) associated with the merchant 122, may generate and submit an authorization request for the financial transaction to the payment network 118. As discussed in more detail below, the payment network 118 may process the financial transaction as a local transaction and not as a cross-border transaction, and return an authorization response to the merchant 122 and/or acquirer. The merchant 122 may then finalize the financial transaction with the employee 112.

The processing server 116 may provide reporting of the financial transaction to the issuer 110. In such an instance, the issuer 110 may receive reports on all financial transactions conducted by employees of the MNC in any subsidiary country. This may enable the issuer 110 to provide comprehensive data regarding spending and transactions to the MNC (e.g., the corporation headquarters 102) without relying on partner issuers or incurring additional fees due to cross-border transactions or licensing of an ICA in the subsidiary countries. In some instances, the payment network 118 may provide additional support to the employee 112, such as level 1 support, which may in turn require fewer resources to be expended by the issuer 110 and necessitate less infrastructure for the issuer 110 in the second country 108. Such support may include providing service to the employee 112 in the local language of the second country 108, providing for call forwarding and access to the issuer 110 for account related inquiries, support regarding the reporting of lost or stolen cards, emergency card replacement, emergency cash advance, and other additional support as will be apparent to persons having skill in the relevant art. In some instances, the processing server 116 and/or payment network 118 may be configured to provide for benefits to the employee 112. For instance, employees 112 may be provided with cardholder benefits in the second country 108 similar to those benefits provided to employees in the first country 106. In some embodiments, this may include insurance benefits consistent with insurance benefits provided in the first country 106.

It will be apparent to persons having skill in the relevant art that the payment network 118 may be configured to perform various functions and processes for or on behalf of the issuer 110. For example, in some instances the issuer 110 may own or license the ICA, which may be purchased or licensed by the payment network 110 on behalf of the issuer 110. In some embodiments, the payment network 118 may provide support to the employee 112 and/or the corporation office 104 in the second country 108. Such support may include balance inquiries, transaction approvals, customer service, or other types of support that will be apparent to persons having skill in the relevant art. In some instances, a large payment network, such as MasterCard® or VISA®, may thereby be configured to provide for such support and processing in a significant number of countries, such as via points of sale, automated teller machines, etc. Furthermore, by providing for processing of the payment transactions, the payment network 118 may have the added benefit of being able to process transactions in markets (e.g., the second country 108) where the payment network 118 may not traditionally process transactions.

By providing such support on behalf of the issuer 110, the payment network 118 may enable the issuer 110 to provide the payment card 114 to the employee 112 in the second country 108, without having to develop additional infrastructure or expend additional resources in the second country 108. This may be further beneficial in instances where the MNC has a small presence in the second country 108, such as a corporation office 104 with only four employees, and to set up a support network for such a presence would be disproportionately expensive and/or consume unnecessary resources. Reporting for transactions by the payment network 118 to the issuer 110 may also provide for the issuer 110 and/or payment network 118 to provide for centralized billing to the corporation, without the need to keep apprised of billing among a plurality of issuers and payment networks. Additional functions performed by the payment network 118 on behalf of the issuer 110 that may further increase the efficiency and/or productivity of the issuer 110 will be apparent to persons having skill in the relevant art.

Processing Device

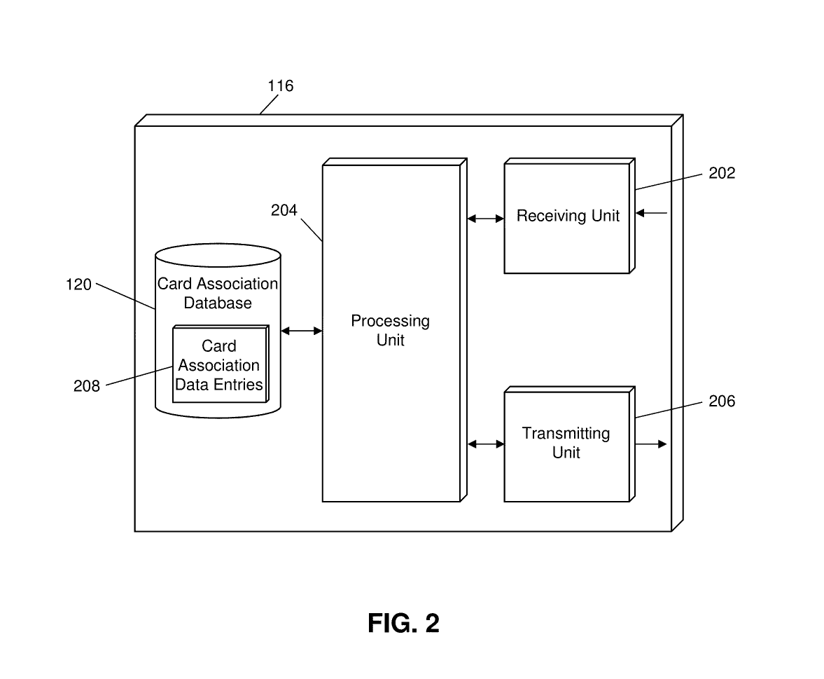

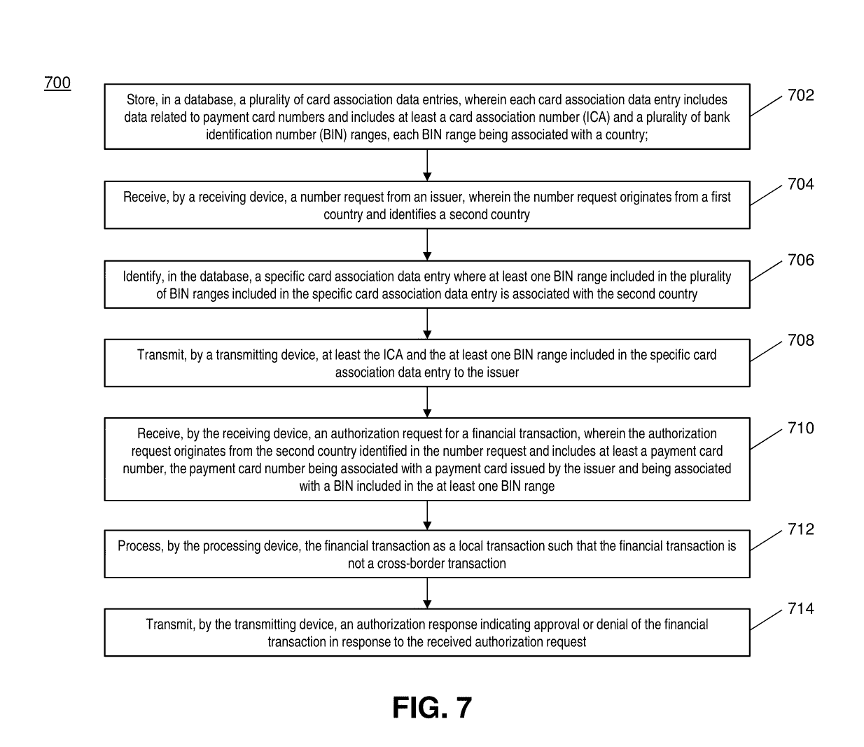

FIG. 2 illustrates an embodiment of the processing server 116 of the system 100. It will be apparent to persons having skill in the relevant art that the embodiment of the processing server 116 illustrated in FIG. 2 is provided as illustration only and may not be exhaustive to all possible configurations of the processing server 116 suitable for performing the functions as discussed herein. For example, the computer system 700 illustrated in FIG. 7 and discussed in more detail below may be a suitable configuration of the processing server 116.

The processing server 116 may include a receiving unit 202. The receiving unit 202 may be configured to receive a number request from the issuer 110. The processing server 116 may also include a processing unit 204, which may be configured to identify the country (e.g., the second country 108) indicated in the number request. The processing unit 204 may then identify a card association data entry 208 included in the card association database 120 that includes an ICA associated with the indicated country.

The processing unit 204 may also be configured to identify a subset of BINs of a plurality of BINs included in the identified card association data entry 208 and associated with the ICA. In some embodiments, the processing unit 204 may indicate the identified subset of BINs and associated issuer 110 in the card association data entry 208. The processing server 116 may include a transmitting unit 206, which may be configured to transmit the identified subset of BINs to the issuer 110 in response to the received number request.

In an alternative embodiment, the processing unit 204 may identify a card association data entry 208 included in the card association database 120 that includes a global ICA not currently associated with an issuer, which also includes at least one BIN range associated with the indicated country. The processing unit 204 may associate the issuer 110 with the identified global ICA and may transmit, via the transmitting unit 206, at least the global ICA and/or the at least one BIN range to the issuer 110 for use in issuing a payment card in the indicated country.

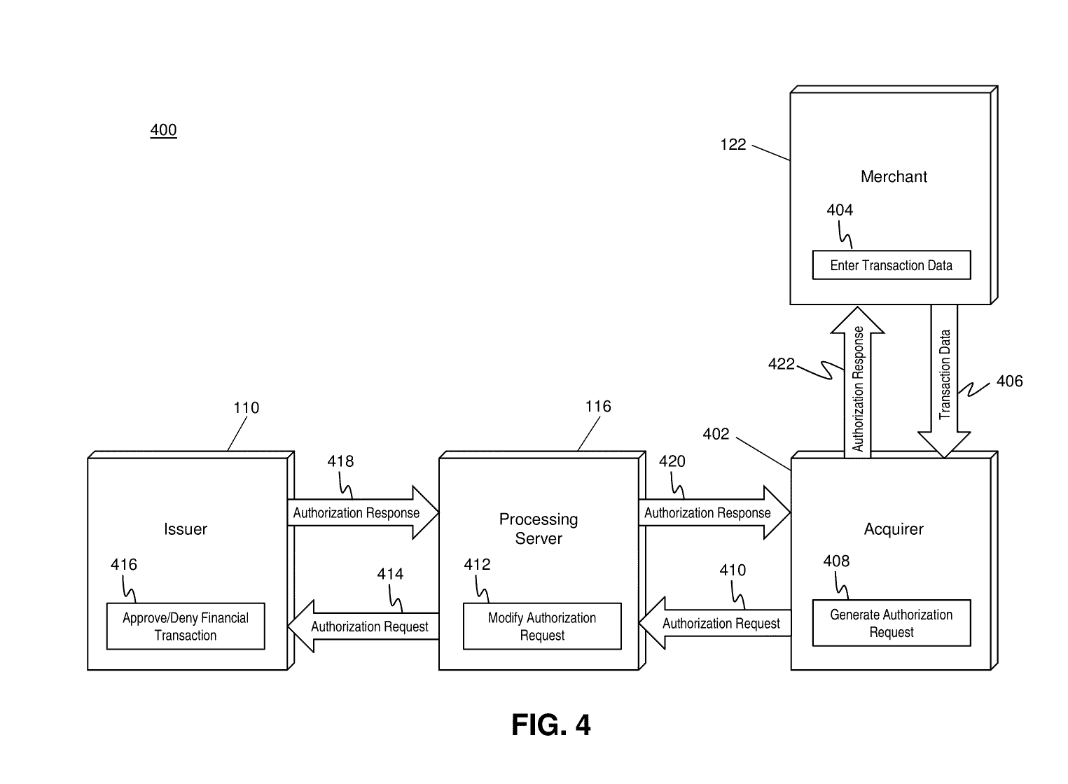

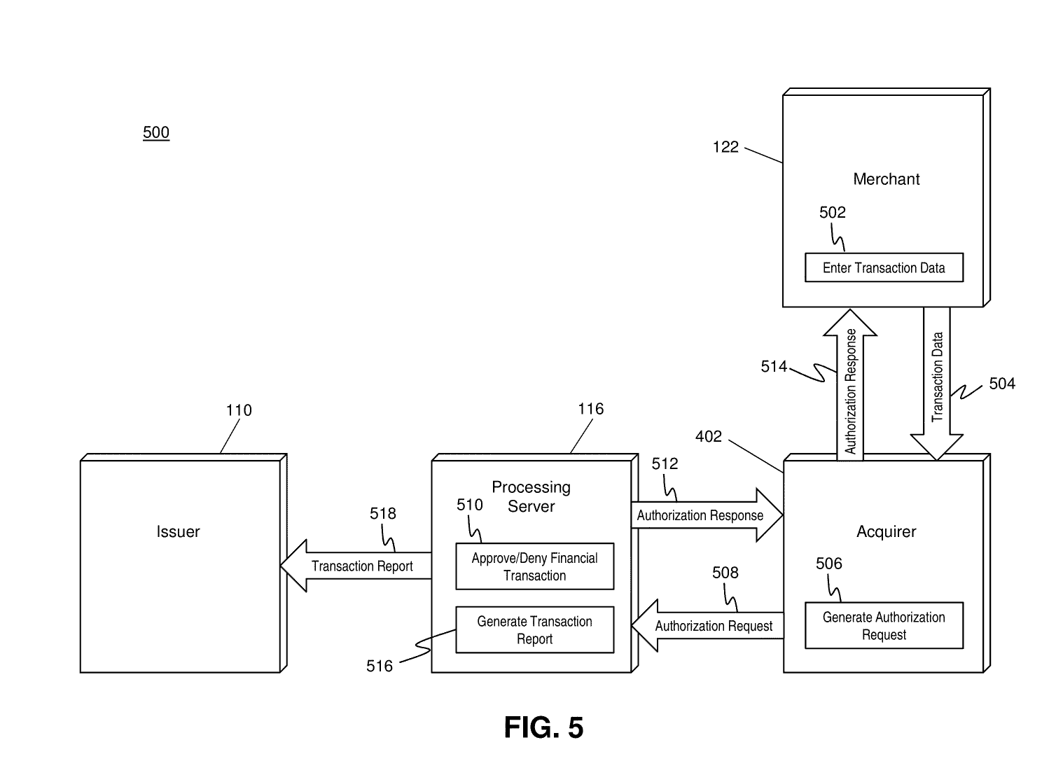

The receiving unit 202 may also be configured to receive an authorization request for a payment card transaction conducting using the payment card 114. The processing unit 204 may identify, in the authorization request, a payment card number associated with the payment card 114. The processing unit 204 may then identify a BIN corresponding to the payment card number, identify the subset of BINs to which the identified BIN is included, and the issuer 110 to which the subset of BINs was associated. The processing unit 204 may then process the financial transaction using methods that will be apparent to persons having skill in the relevant art, as discussed below with respect to FIGS. 4 and 5. The processing of the transaction may yield an authorization response, which may be transmitted by the transmitting unit 206 to the merchant 122 and/or acquirer as a response to the authorization request.

### Method for Issuing Payment Card and Facilitating Payment Transactions

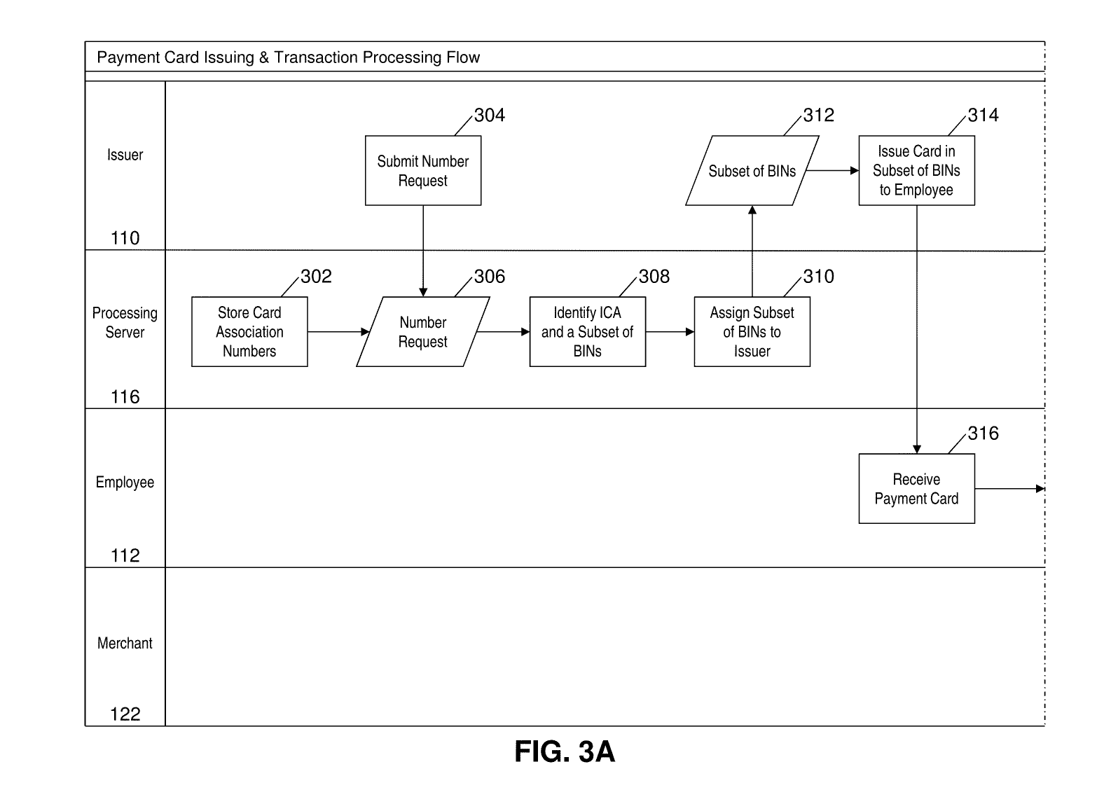

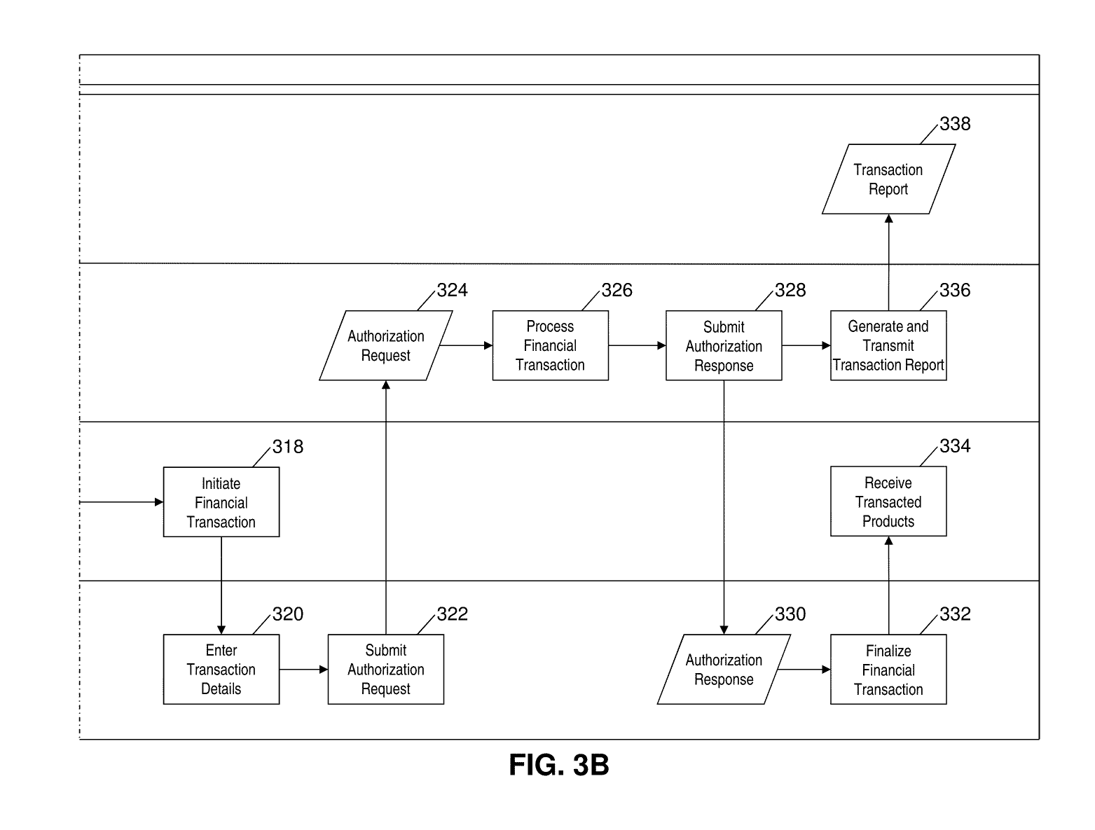

FIGS. 3A and 3B illustrate a processing flow for the issuing of the payment card 114 in the system of FIG. 1 and facilitating of a payment transaction involving the payment card 114 as a local transaction via the processing server 116.

In step 302, the processing server 116 may store ICAs in card association data entries 208 in the card association database 120. Each ICA may be associated with a country, which may also be included in the corresponding card association data entry 208. Each ICA may also be associated with a plurality of BINs, which may be stored in the corresponding card association data entry 208.

In step 304, the issuer 110 may submit a number request to the processing server 116, which may receive the number request in step 306. The number request may indicate a country, such as the second country 108, in which the issuer 110 would like to issue payment cards. Then, in step 308, the processing server 116 may identify a card association data entry 208 including an ICA associated with the country indicated in the number request, and may identify an unassigned subset of BINs in the plurality of BINs in the identified card association data entry 208. In an alternative embodiment, the processing server 116 may identify a card association data entry 208 including a global ICA that is associated with at least one BIN range associated with the indicated country.

In step 310, the processing server 116 may assign (e.g., in the card association database 120) the identified subset of BINs to the issuer 110 and may transmit the subset of BINs to the issuer 110. In the alternative embodiment, the processing server 116 may assign the global ICA to the issuer 110 and may transmit the at least one BIN range associated with the indicated country to the issuer 110. In step 312, the issuer 110 may receive the subset of BINs, which are associated with the country as requested in the previously submitted number request. In step 314, the issuer 110 may issue the payment card 114 to the employee 112, which may be associated with a payment card number included in the received subset of BINs. Methods and systems suitable for identifying a payment card number corresponding a specific or range of BINs will be apparent to persons having skill in the relevant art.

In step 316, the employee 112, located in the indicated country, may receive the payment card 114. Then, in step 318, the employee 112 may initiate a financial transaction with the merchant 122 using the issued payment card 114. In an exemplary embodiment, the merchant 122 is also located in the country (e.g., the second country 108) indicated in the number request. In step 320, the merchant 122 may enter transaction details for the transaction into a point-of-sale system. The transaction details may include, for example, product details, product codes, product prices, shipping information, quantity information, payment details, etc. In step 322, the merchant 122 may submit an authorization request for the transaction to the processing server 116. In some embodiments, the merchant 122 may first transmit the transaction data to an acquirer associated with the merchant 122, which may then generate and submit the authorization request to the processing server 116.

In step 324, the processing server 116 may receive the authorization request. The authorization request may include at least transaction data related to the payment transaction including payment details and a transaction amount. In an exemplary embodiment, the transaction amount may be represented in a currency associated with the country from which the authorization request originates (e.g., the second country 108). In step 326, the processing server 116 may process the financial transaction. Methods suitable for processing the financial transaction will be apparent to persons having skill in the relevant art, such as those methods discussed below with respect to FIGS. 4 and 5.

In step 328, the processing server 116 may submit an authorization response indicating approval or denial of the financial transaction to the merchant 122 and/or acquirer. In step 332, the merchant 122 may finalize the financial transactions depending on its approval or denial, such as by providing the transacted for products (e.g., goods or services) to the employee 112, who may receive the products in step 334. In step 336, the processing server 116, following the processing of the financial transaction, may generate a report of the financial transaction and submit it to the issuer 110. The issuer 110 may receive the report in step 338, which it may evaluate and/or make available to the MNC. It will be apparent to persons having skill in the relevant art that the report may include data and/or evaluations as indicated by the MNC.

### Methods for Processing a Financial Transaction

FIG. 4 illustrates a method 400 for processing a financial transaction using the system 100 of FIG. 1.

In step 404, the merchant 122, located in the second country 108, may enter transaction data in a point-of-sale system. Methods for entering transaction data for a financial transaction will be apparent to persons having skill in the relevant art. The transaction data may include at least a transaction amount and payment details, which may further include a payment card number associated with the payment card 114. The merchant 122 may forward the transaction data, in step 406, to an acquirer 402. Then, in step 408, the acquirer 402 may generate an authorization request for the transaction based on the transaction data. In some embodiments, the authorization request may be formatted pursuant to one or more standards, such as the International Organization for Standardization's ISO 8583 standard.

In step 410, the acquirer 402 may submit the authorization request to the processing server 116. The processing server 116 may then, in step 412, modify the authorization request. Modification of the authorization request may include converting the transaction amount from a currency associated with the second country 108 into a currency associated with the first country 106. Methods suitable for exchanging currency in an authorization request for processing will be apparent to persons having skill in the relevant art. In step 414, the processing server 116 may forward the authorization request as modified to the issuer 110.

In step 416, the issuer 110 may approve or deny the financial transaction using systems and methods that will be apparent to persons having skill in the relevant art, such as denying the financial transaction if the employee 112 associated with the payment card 114 used in the transaction does not have enough credit available to cover the transaction amount. It will also be apparent to persons having skill in the relevant art that step 412 may be optional, and the issuer 110 may approve or deny the financial transaction based on the transaction amount represented by the currency associated with the second country 108 without the need to exchange the currency. In an alternative embodiment, the issuer 110 may perform a currency exchange into a currency associated with the first country 106 prior to approving or denying the financial transaction.

In step 418, the issuer 110 may submit an authorization response to the processing server 116 indicating approval or denial of the transaction, which may be forward by the processing server 116 to the acquirer 402 in step 420. The acquirer 402 may then submit a response, of forward the authorization response, to the merchant 122 in step 422, indicating approval or denial of the financial transaction. The merchant 122 may then finalize the transaction accordingly.

FIG. 5 illustrates an alternative method 500 for the processing of the financial transaction.

In step 502, the merchant 122 may enter transaction data in a point-of-sale system. The transaction data may include at least a transaction amount and payment details, which may further include a payment card number associated with the payment card 114. The transaction amount may be represented in a currency associated with the second country 108. The merchant 122 may forward the transaction data, in step 504, to an acquirer 402. Then, in step 506, the acquirer 402 may generate an authorization request for the transaction based on the transaction data.

In step 508, the acquirer 402 may submit the authorization request to the processing server 116. The processing server 116 may then, in step 510, approve or deny the financial transaction using methods that will be apparent to persons having skill in the relevant art. The approval or denial of the transaction by the processing server 116 may enable the transaction to be processed faster, and more efficiently, and not require any calculation or estimation of currency exchange. The processing server 116 may generate an authorization response based on the approval or denial, and may submit the authorization response to the acquirer 402 in step 512. The acquirer 402 may then, in step 514, forward the response to the merchant 122.

In step 516, the processing server 116 may generate a transaction report. The transaction report may include data as indicated by the issuer 110, such as the employee 112 and/or the payment card 114 involved in the transaction and the transaction amount. The transaction amount may be represented by a currency associated with the second country 108 and/or a currency associated with the first country 106 in which the issuer 110 is primarily located. Additional data that may be included in a transaction report will be apparent to persons having skill in the relevant art. In step 518, the processing server 116 may transmit the report to the issuer 110.

Methods discussed herein may enable the processing server 116 to process the financial transaction as a local transaction such that the transaction is not a cross-border transaction. As a result, the transaction may be processed with less expense incurred by the issuer 110, which may in turn provide savings to the MNU.

### First Exemplary Method for Facilitating a Payment Card Transaction

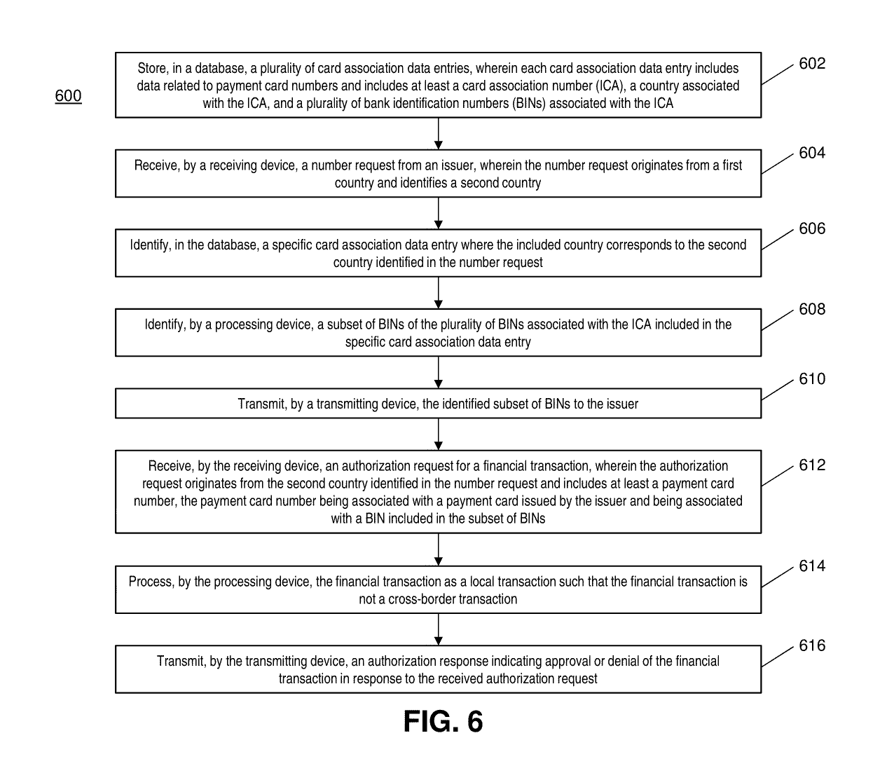

FIG. 6 illustrates an exemplary method 600 for facilitating a payment card transaction as a local transaction using the system 100 of FIG. 1.

In step 602, a plurality of card association data entries (e.g., card association data entries 208) may be stored in a database (e.g., the card association database 120), wherein each card association data entry 208 includes data related to payment card numbers and includes at least a card association number (ICA), a country associated with the ICA, and a plurality of bank identification numbers (BINs) associated with the ICA. In step 604, a receiving device (e.g., the receiving unit 202) may receive a number request from an issuer (e.g., the issuer 110), wherein the number request originates from a first country (e.g., the first country 106) and identifies a second country (e.g., the second country 108).

In step 606, a specific card association data entry 208 may be identified in the database 120 where the included country corresponds to the second country 108 identified in the number request. In step 608, a processing device (e.g., the processing unit 204) may identify a subset of BINs in the plurality of BINs associated with the ICA included in the specific card association data entry 208. In one embodiment, each BIN in the subset of BINs may include at least two common digits.

In step 610, the identified subset of BINs may be transmitted, by a transmitting device (e.g., the transmitting unit 206) to the issuer 110. In step 612, the receiving device 202 may receive an authorization request for a financial transaction, wherein the authorization request originates from the second country 108 identified in the number request and includes at least a payment card number, the payment card number being associated with a payment card (e.g., the payment card 114) issued by the issuer 110 and being associated with a BIN included in the subset of BINs. In one embodiment, the authorization request may include at least a transaction amount represented in a currency associated with the second country 108.

In step 614, the processing device 204 may process the financial transaction as a local transaction such that the financial transaction is not a cross-border transaction. In one embodiment, step 614 may include transmitting, by the transmitting device 206, the authorization request to the issuer 110 and receiving, by the receiving device 202, a response from the issuer 110 indicating approval or denial of the financial transaction. In a further embodiment, the authorization request may include a transaction amount represented in a second currency associated with the second country 108, and the method 600 may include replacing, in the authorization request, the transaction amount with a modified transaction amount represented in a first currency associated with the first country 106 based on an exchange rate between the first currency and the second currency, wherein the transaction amount is replaced in the authorization request prior to transmission to the issuer 106.

In step 616, the transmitting device 206 may transmit an authorization response indicating approval or denial of the financial transaction in response to the received authorization request. In one embodiment, the method 600 may further include generating, by the processing device 204, a report of the financial transaction based on the authorization request, and transmitting, by the transmitting device 206, the report of the financial transaction to the issuer 110. In a further embodiment, the authorization request may further include a transaction amount represented in a second currency associated with the second country 108, the generating of the report may include identifying, by the processing device 204, an exchanged transaction amount represented in a first currency associated with the first country 106 based on an exchange rate between the first currency and the second currency, and the exchanged transaction amount may be included in the report of the financial transaction.

### Second Exemplary Method for Facilitating a Payment Card Transaction

FIG. 7 illustrates an exemplary method 700 for facilitating a payment card transaction as a local transaction using the system 100 of FIG. 1.

In step 702, a plurality of card association data entries (e.g., card association data entries 208) may be stored in a database (e.g., the card association database 120), wherein each card association data entry 208 includes data related to payment card numbers and includes at least a card association number (ICA) and a plurality of bank identification number (BIN) ranges, each BIN range being associated with a country. In step 704, a receiving device (e.g., the receiving unit 202) may receive a number request from an issuer (e.g., the issuer 110), wherein the number request originates from a first country (e.g., the first country 106) and identifies a second country (e.g., the second country 108).

In step 706, a specific card association data entry 208 may be identified in the database 120 where at least one BIN range included in the plurality of BIN ranges included in the specific card association data entry 208 is associated with the second country 108. In one embodiment, each BIN in a BIN range may include at least two common digits.

In step 708, at least the ICA and at least one BIN range may be transmitted, by a transmitting device (e.g., the transmitting unit 206) to the issuer 110. In step 710, the receiving device 202 may receive an authorization request for a financial transaction, wherein the authorization request originates from the second country 108 identified in the number request and includes at least a payment card number, the payment card number being associated with a payment card (e.g., the payment card 114) issued by the issuer 110 and being associated with a BIN included in the at least one BIN range. In one embodiment, the authorization request may include at least a transaction amount represented in a currency associated with the second country 108.

In step 712, the processing device 204 may process the financial transaction as a local transaction such that the financial transaction is not a cross-border transaction. In one embodiment, step 712 may include transmitting, by the transmitting device 206, the authorization request to the issuer 110 and receiving, by the receiving device 202, a response from the issuer 110 indicating approval or denial of the financial transaction. In a further embodiment, the authorization request may include a transaction amount represented in a second currency associated with the second country 108, and the method 700 may include replacing, in the authorization request, the transaction amount with a modified transaction amount represented in a first currency associated with the first country 106 based on an exchange rate between the first currency and the second currency, wherein the transaction amount is replaced in the authorization request prior to transmission to the issuer 106.

In step 714, the transmitting device 206 may transmit an authorization response indicating approval or denial of the financial transaction in response to the received authorization request. In one embodiment, the method 700 may further include generating, by the processing device 204, a report of the financial transaction based on the authorization request, and transmitting, by the transmitting device 206, the report of the financial transaction to the issuer 110. In a further embodiment, the authorization request may further include a transaction amount represented in a second currency associated with the second country 108, the generating of the report may include identifying, by the processing device 204, an exchanged transaction amount represented in a first currency associated with the first country 106 based on an exchange rate between the first currency and the second currency, and the exchanged transaction amount may be included in the report of the financial transaction.

### Computer System Architecture

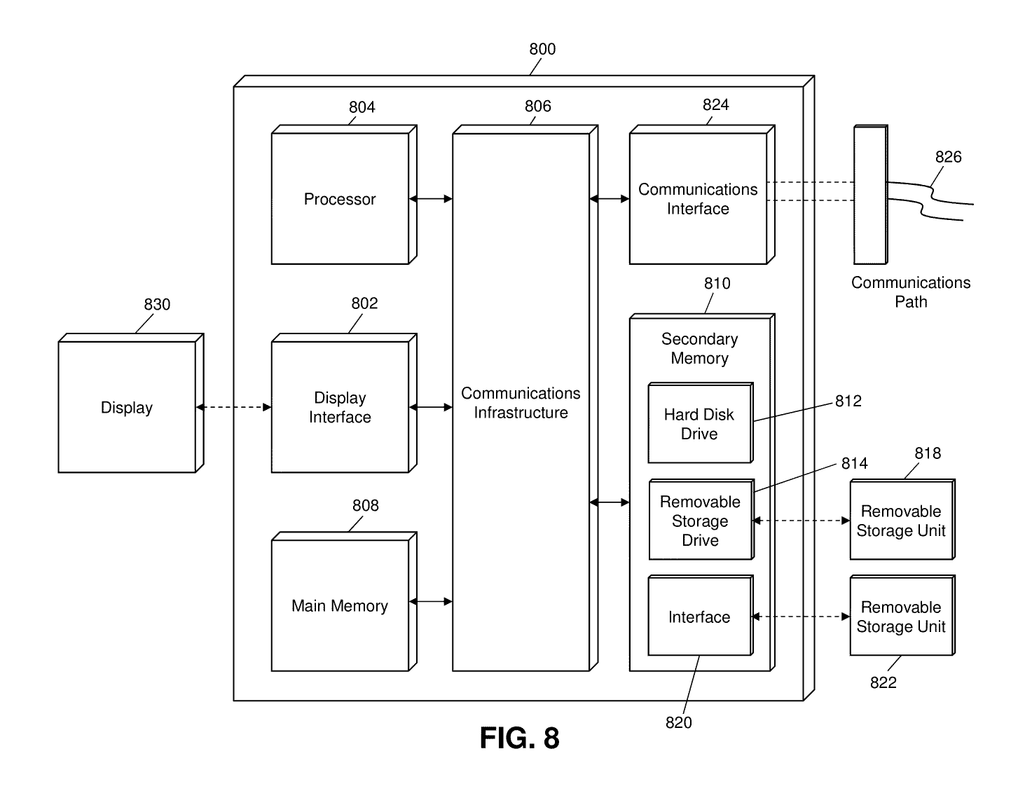

FIG. 8 illustrates a computer system 800 in which embodiments of the present disclosure, or portions thereof, may be implemented as computer-readable code. For example, the processing server 116 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 4-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3A, 3B, and 4-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for facilitating payment card transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for facilitating a payment card transaction, comprising:
storing, in a database, a plurality of card association data entries, wherein each card association data entry includes data related to payment card numbers and includes at least a card association number (ICA), a country associated with the ICA, and a plurality of bank identification numbers (BINs) associated with the ICA;
receiving, by a receiving device, a number request from an issuer, wherein the number request originates from a first country and identifies a second country;
identifying, in the database, a specific card association data entry where the included country corresponds to the second country identified in the number request;
identifying, by a processing device, a subset of BINs of the plurality of BINs associated with the ICA included in the specific card association data entry;
transmitting, by a transmitting device, the identified subset of BINs to the issuer;
receiving, by the receiving device, an authorization request for a financial transaction, wherein the authorization request originates from the second country identified in the number request and includes at least a payment card number, the payment card number being associated with a payment card issued by the issuer and being associated with a BIN included in the subset of BINs;
processing, by the processing device, the financial transaction as a local transaction such that the financial transaction is not a cross-border transaction; and
transmitting, by the transmitting device, an authorization response indicating approval or denial of the financial transaction in response to the received authorization request.

2. The method of claim 1, wherein processing the financial transaction includes transmitting, by the transmitting device, the authorization request to the issuer, and receiving, by the receiving device, a response from the issuer indicating approval or denial of the financial transaction.

3. The method of claim 2, wherein the authorization request further includes a transaction amount represented in a second currency associated with the second country, and the method further comprises:
replacing, in the authorization request, the transaction amount with a modified transaction amount represented in a first currency associated with the first country based on an exchange rate between the first currency and the second currency, wherein the transaction amount is replaced in the authorization request prior to transmission to the issuer.

4. The method of claim 1, further comprising:
generating, by the processing device, a report of the financial transaction based on the authorization request; and
transmitting, by the transmitting device, the report of the financial transaction to the issuer.

5. The method of claim 4, wherein
the authorization request further includes a transaction amount represented in a second currency associated with the second country,
generating the report of the financial transaction includes identifying, by the processing device, an exchanged transaction amount represented in a first currency associated with the first country based on an exchange rate between the first currency and the second currency, and
the exchanged transaction amount is included in the report of the financial transaction.

6. The method of claim 1, wherein each BIN in the subset of BINs is a consecutive number.

7. The method of claim 1, wherein each BIN in the subset of BINs includes at least two common digits.

8. The method of claim 1, wherein the authorization request includes at least a transaction amount represented in a currency associated with the second country.

9. A method for facilitating a payment card transaction, comprising:
storing, in a database, a plurality of card association data entries, wherein each card association data entry includes data related to payment card numbers and includes at least a card association number (ICA) and a plurality of bank identification number (BIN) ranges, each BIN range being associated with a country;
receiving, by a receiving device, a number request from an issuer, wherein the number request originates from a first country and identifies a second country;
identifying, in the database, a specific card association data entry where at least one BIN range included in the plurality of BIN ranges included in the specific card association data entry is associated with the second country;
transmitting, by a transmitting device, at least the ICA and the at least one BIN range included in the specific card association data entry to the issuer;
receiving, by the receiving device, an authorization request for a financial transaction, wherein the authorization request originates from the second country identified in the number request and includes at least a payment card number, the payment card number being associated with a payment card issued by the issuer and being associated with a BIN included in the at least one BIN range;
processing, by the processing device, the financial transaction as a local transaction such that the financial transaction is not a cross-border transaction; and
transmitting, by the transmitting device, an authorization response indicating approval or denial of the financial transaction in response to the received authorization request.

10. A system for facilitating a payment card transaction, comprising:
a database configured to store a plurality of card association data entries, wherein each card association data entry includes data related to payment card numbers and includes at least a card association number (ICA), a country associated with the ICA, and a plurality of bank identification numbers (BINs) associated with the ICA;
a receiving device configured to receive a number request from an issuer, wherein the number request originates from a first country and identifies a second country;
a processing device configured to
identify, in the database, a specific card association data entry where the included country corresponds to the second country identified in the number request, and
identify a subset of BINs of the plurality of BINs associated with the ICA included in the specific card association data entry; and
a transmitting device configured to transmit the identified subset of BINs to the issuer, wherein
the receiving device is further configured to receive an authorization request for a financial transaction, the authorization request originating from the second country identified in the number request and includes at least a payment card number, and the payment card number being associated with a payment card issued by the issuer and being associated with a BIN included in the subset of BINs,
the processing device is further configured to process the financial transaction as a local transaction such that the financial transaction is not a cross-border transaction, and
the transmitting device is further configured to transmit an authorization response indicating approval or denial of the financial transaction in response to the received authorization request.

11. The system of claim 10, wherein the processing device is configured to process the financial transaction by
causing the transmitting device to transmit the authorization request to the issuer, and
causing the receiving device to receive a response from the issuer indicating approval or denial of the financial transaction.

12. The system of claim 11, wherein
the authorization request further includes a transaction amount represented in a second currency associated with the second country,
the processing device is further configured to replace, in the authorization request, the transaction amount with a modified transaction amount represented in a first currency associated with the first country based on an exchange rate between the first currency and the second currency, and
the processing device is configured to replace the transaction amount in the authorization request prior to causing the transmitting device to transmit the authorization request to the issuer.

13. The system of claim 10, wherein
the processing device is further configured to generate a report of the financial transaction based on the authorization request, and
the transmitting device is further configured to transmit the report of the financial transaction to the issuer.

14. The system of claim 13, wherein
the authorization request further includes a transaction amount represented in a second currency associated with the second country,
the processing device is configured to generate the report of the financial transaction by identifying an exchanged transaction amount represented in a first currency associated with the first country based on an exchange rate between the first currency and the second currency, and
the exchanged transaction amount is included in the report of the financial transaction.

15. The system of claim 10, wherein each BIN in the subset of BINs is a consecutive number.

16. The system of claim 10, wherein each BIN in the subset of BINs includes at least two common digits.

17. The system of claim 10, wherein the authorization request includes at least a transaction amount represented in a currency associated with the second country.

18. A system for facilitating a payment card transaction, comprising:
a database configured to store a plurality of card association data entries, wherein each card association data entry includes data related to payment card numbers and includes at least a card association number (ICA) and a plurality of bank identification number (BIN) ranges, each BIN range being associated with a country;
a receiving device configured to receive a number request from an issuer, wherein the number request originates from a first country and identifies a second country;
a processing device configured to identify, in the database, a specific card association data entry where at least one BIN range included in the plurality of BIN ranges included in the specific card association data entry is associated with the second country; and
a transmitting device configured to transmit at least the ICA and the at least one BIN range included in the specific card association data entry to the issuer, wherein
the receiving device is further configured to receive an authorization request for a financial transaction, wherein the authorization request originates from the second country identified in the number request and includes at least a payment card number, the payment card number being associated with a payment card issued by the issuer and being associated with a BIN included in the at least one BIN range,
the processing device is further configured to process the financial transaction as a local transaction such that the financial transaction is not a cross-border transaction, and
the transmitting device is further configured to transmit an authorization response indicating approval or denial of the financial transaction in response to the received authorization request.
